(19) United States
(12) Patent Application Publication
(10) Pub. No.: US 2005/0122248 A1
(43) Pub. Date: Jun. 9, 2005

(54) Emitting device for generating new codes

(76) Inventors: Chung-Min Chang, Taichung (TW); Liao-Yin Sheng, Longjing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/729,954

(22) Filed: Dec. 9, 2003

(51) Int. Cl. H04L 17/02; G08C 19/12

(52) U.S. Cl. 341/173; 340/825.72

(57) ABSTRACT

An emitting device includes a plurality of buttons and can be entered into the processes of encoding, learning mold and quick encoding by the operation of the buttons. In the processes of the encoding, the encoding is generated by mixing the values of buttons, the value of time and value of RTCC to generate random code which is stored in different memory areas in a button corresponding thereto so that the user may press the buttons to send the corresponding codes and can encode within a short period of time.

### FIELD OF THE INVENTION

The present invention relates to an emitting device that stores new codes in corresponding buttons and the new codes are generated by setting different ways of operation of buttons.

### BACKGROUND OF THE INVENTION

A conventional emitting device generally use switches to encode or the codes are set in manufacturing sites and cannot be changed. Some have specific buttons having pre-set values. If the codes are to be amended to changed, an encoder is used to input the individual codes. This is not convenient for the users because this can only be done in manufacturing sites or using special tools.

The present invention intends to provide an emitting device that is able to encode when needed.

### SUMMARY OF THE INVENTION

The present invention relates to an emitting device which comprises a body having a plurality sets of buttons and a rest button. The buttons and the reset button are connected with an MCU which is connected to a power supply system, a generator, a receiver and warning lamps. The steps for encoding and emitting of the emitting device comprises:
reset: the reset button being pressed;
initial setting: a system establishing an initial value and the exterior power being shut down when the values becomes their original values;
reading the operation of the buttons: if no button is pressed then go to the previous step;
reading the value of the first button: pressing the first button and reading the stored value in the first button;
reading the value of the second button: pressing the second button and reading the stored value in the second button;
reading the value of the third button: pressing the third button and reading the stored value in the third button;
reading the value of the fourth button: pressing the fourth button and reading the stored value in the fourth button;
the system proceeding the following steps after the four buttons are pressed:
sending: cooperating with the exterior power supply and sending a mixture of the read value of the buttons in a form of 32 bit code and 4 bit status value;
sending the codes per-set times: counting the times of sending, if the times reach the desired value, if no sending is completed then go to the previous step, if the sending is completed then go to the next step;
detecting change of the values of the buttons: detecting the values of the buttons, if no change is detected then go to read the previous step, if a change is detected then go to the next step, and
checking the button is pressed or not: checking the button is pressed or not, if no, terminate the jab, if yes, go to time storage to store time.

When encoding, using different button to set different functions, comprising:
encoding process: pressing at least one set of the first buttons simultaneously to re-set different codes for the buttons;
learning mold: pressing at least one set of buttons simultaneously to learn and confirm the codes, and
quick encoding process: pressing the first button and the second button simultaneously to proceed quick encode.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a block diagram of the emitting device of the present invention;

FIG. 2 shows the steps for encoding of the emitting device of the present invention;

Fig, 3 shows the steps of encoding processes;

FIG. 4 shows the steps of learning mold, and

FIG. 5 shows the steps of time storage.

### DETAILED DESCRIPTION OF THE PREFERRED EMBODIMENT

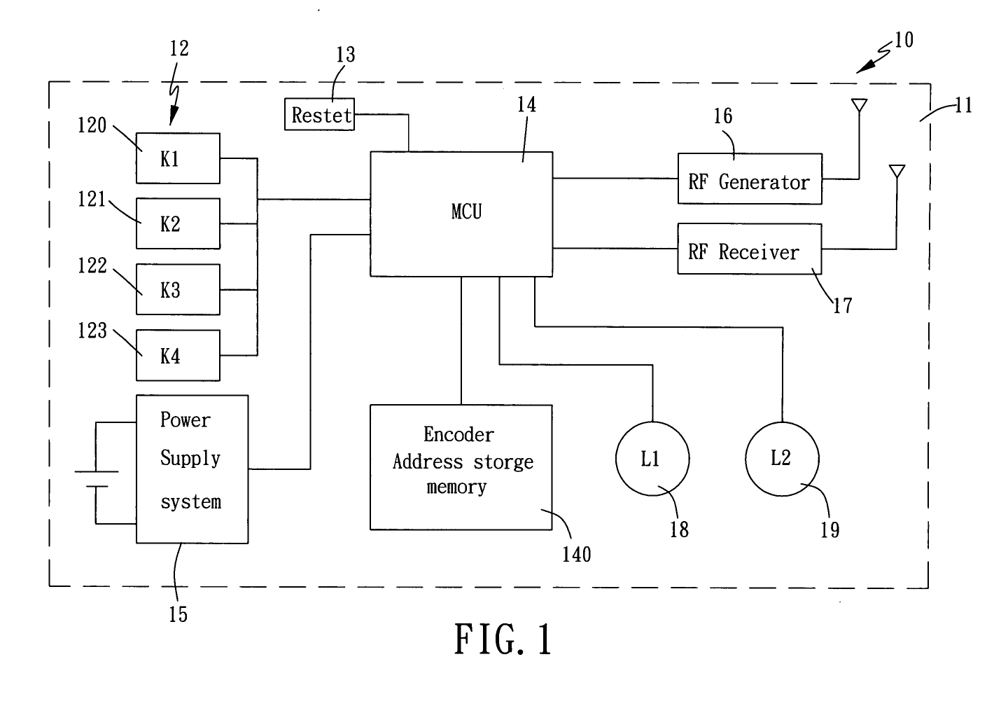

Referring to FIG. 1, the hardware of the emitting device 10 of the present invention comprises a body 11 which includes at least four sets of buttons 12 and a rest button 13. These buttons 12 and the reset button 13 is connected with an MCU 14 which is connected to a power supply system 15, a generator 16, a receiver 17 and two warning lamps 18 and 19.

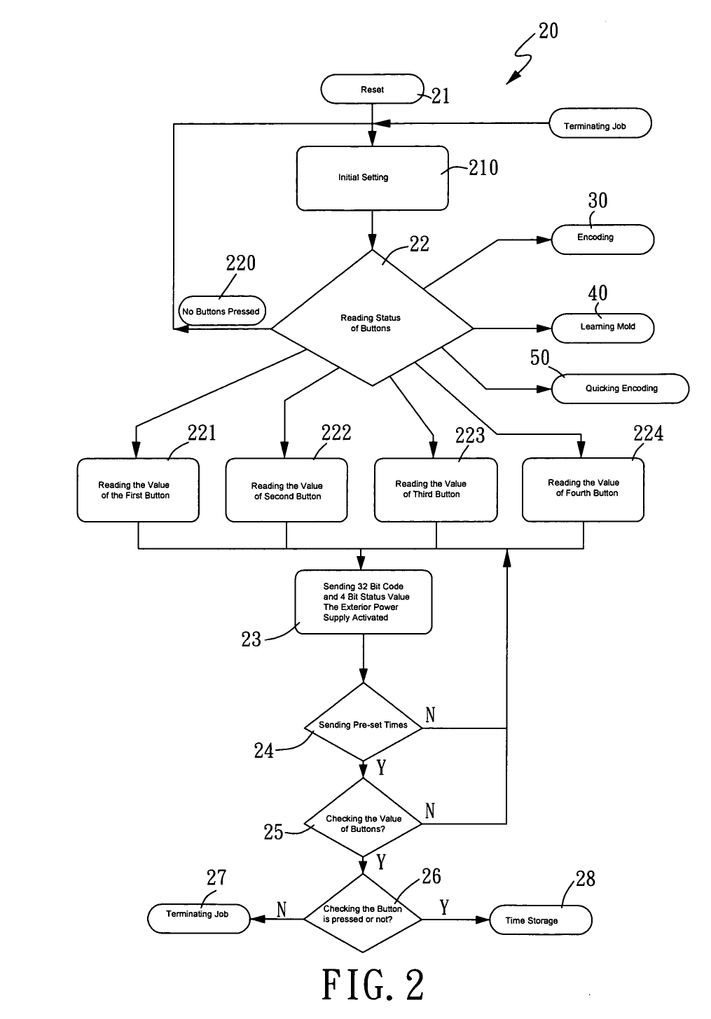

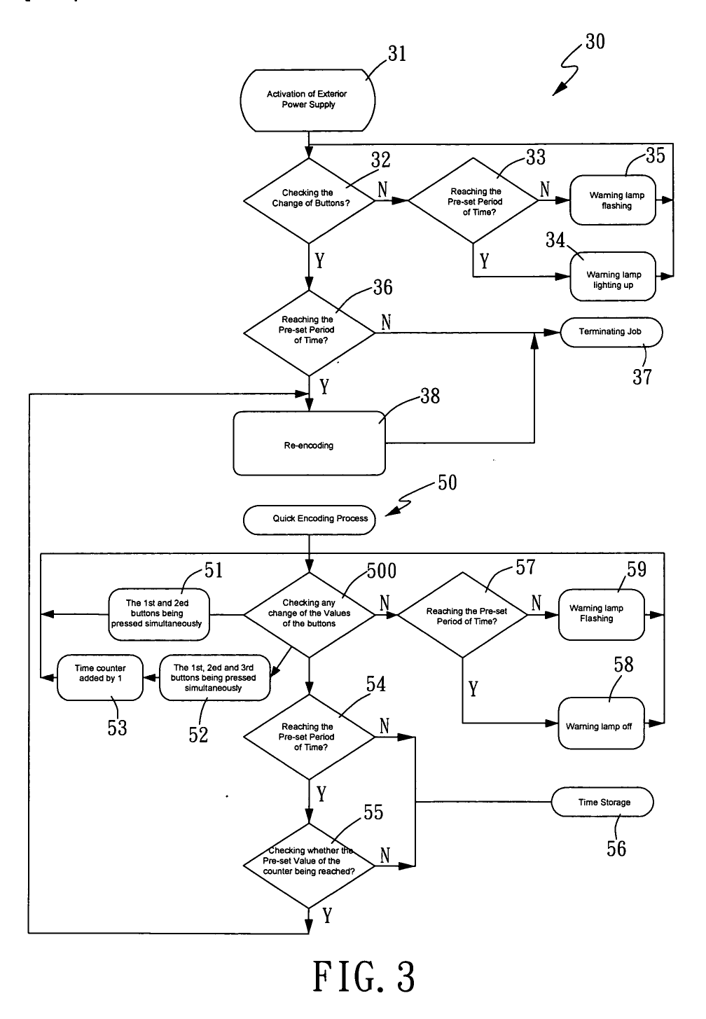

As shown in FIG. 2, the steps for encoding and emitting of the emitting device 10 comprises:
reset 21: the reset button 13 is pressed;
initial setting 210: the system establish an initial value and the exterior power is shut down when the values becomes their original values;
reading the operation of the buttons 22: if no button is pressed 220 then go to the previous step;
reading the value of the first button 221: pressing the first button 120 and reading the stored value in the first button 120;
reading the value of the second button 222: pressing the second button 121 and reading the stored value in the second button 121;
reading the value of the third button 223: pressing the third button 122 and reading the stored value in the third button 122;
reading the value of the fourth button 224: pressing the fourth button 123 and reading the stored value in the fourth button 123;

The system proceeds the following steps after the four buttons are pressed:
sending 23: cooperating with the exterior power supply and sending a mixture of the read value of the buttons in a form of 32 bit code and 4 bit status value;
sending per-set times 24: counting the times of sending, when the times reach the desired value, if no sending is completed then go to the previous step, if the sending is completed then go to the next step;
detecting change of the values of the buttons 25: detecting the values of the buttons, if no change is detected then go to read the previous step, if a change is detected then go to the next step;
checking the button is pressed or not 26: checking the button is pressed or not, if no, terminate the jab 27, if yes, go to time storage 28 to store time.

When encoding, using different button to set different functions, comprising:
encoding process 30: pressing the first button 120, the second button 121 and the third button 122 simultaneously to re-set different codes for the buttons;
learning mold 40: pressing the first button 120 and the third button 122 simultaneously to learn and confirm the codes;
quick encoding process 50: pressing the first button 120 and the second button 121 simultaneously to proceed quick encode;

The processes for encoding 30 are disclosed in FIG. 3, and comprise:
activation of exterior power supply 30: activating the exterior power supply to proceed the encoding processes;
checking the change of the buttons 32: if no change is detected, checking whether it reaches the pre-set period of time 33, if it reaches the pre-set period of time such as 30 seconds, the warning lamp 34 lights up and the warning lamps 18 and 19 illuminate all the time, go to the previous step, if it does not reach the pre-set period of time, the warning lamp 35 flashes and the two warning lamps 18 and 19 flash and go to the previous step; if the value of the button is changed, checking whether it reaches the pre-set period of time such as 30 seconds, if no, then proceed time storage 37, if yes, then proceed encoding 38.

The encoding 38 is to mix the values of buttons, the value of time and value of RTCC to generate a 4 bit random code which is stored in a button corresponding thereto. The status of the value is stored in each value of button.

quick encoding process 50: checking any change of the values of the buttons 500, if the first and the second buttons 51 are pressed simultaneously, the fist and the second buttons 120, 121 are in ON status, then go to the previous step; if the first, the second and the third buttons 52 are pressed simultaneously, and the three buttons 120, 121, 122 are ON, the counter 53 will be added by “one (1)” and goes to the previous step; if the situations are different from the situations mentioned above, checking whether the time reaches the pre-set period of time 54, if yes, then checking whether reaches the pre-set value of the counter 55, the pre-set value is five, if the accumulation of the value reaches five, go to the process of encoding 38 to proceed quick encoding and storing; if neither of the time and the value of the counter is reached, proceed the process of time storage 56; if the change of the value of buttons 51 is confirmed to be negative, then go to check whether the time reaches the pre-set time 57, if yes, the warning lamp off, if no, the warning lamp flashing 59, and go to the previous step.

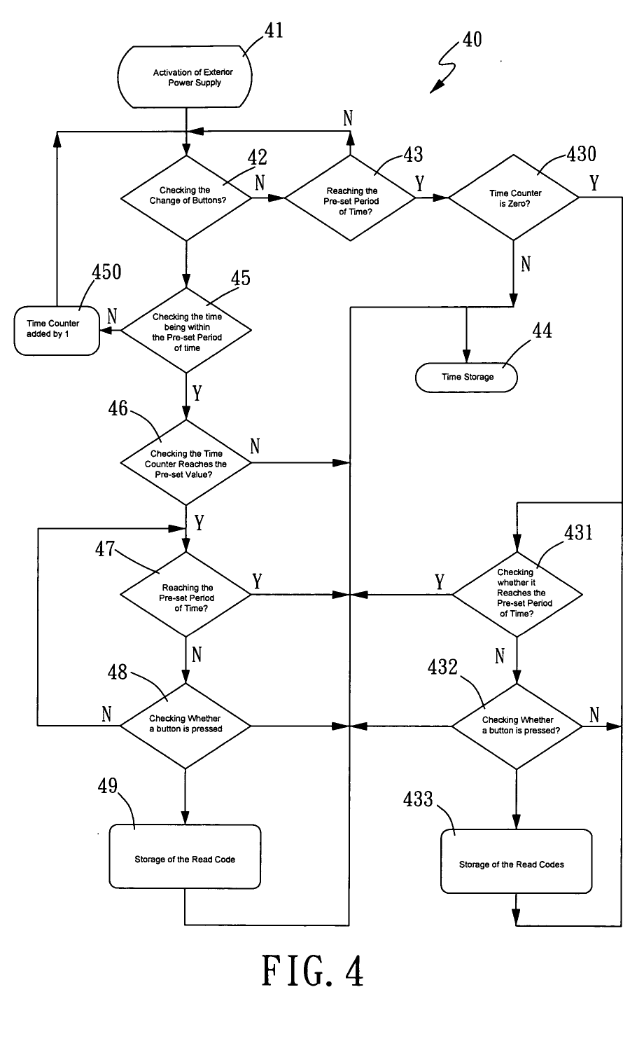

The learning mold 40 is disclosed in FIG. 4, comprising:
activation of exterior power supply 41: activating the exterior power supply to proceed encoding processes;

Checking the change of the buttons 42: if no change is detected, checking whether it reaches the pre-set period of time 43, if no, go to the previous step, if yes, it reaches the pre-sect period of time of 30 seconds, checking whether the time counter is zero 430, if no, proceed time storage 44, if it is zero, checking whether it reaches pre-set period of time 431 which is about 10 seconds, if no, checking whether the button is pressed 432, if no, go to the previous step, if yes and the three buttons 120, 121, 122 or the first and the third buttons 120, 122 are pressed simultaneously, go to the time storage 44, if the button is other than the three buttons 120, 121, 122, then proceed storage of the read codes 433 by storing the codes and status read by legs into corresponding buttons, if the buttons are pressed other than the three buttons being pressed simultaneously, then check the time is within two seconds, if no, then go to the previous step by adding one 450 to the time counter, if yes, checking the value of the time counter reaches the pre-set value 46, if no, then go to the time storage 44, if yes, then check whether it reaches the pre-set period of time 47, if yes, then proceed the time storage 44, if no, check whether a button is pressed 48, if no, go to the previous step, if yes, and the three buttons 120, 121, 122 are pressed simultaneously or the first and the third button 120, 122 are pressed simultaneously, then go to the status of time storage 44, if any other button is pressed, then proceed the storage of read code 49 by storing the code and the status read by legs into the corresponding buttons.

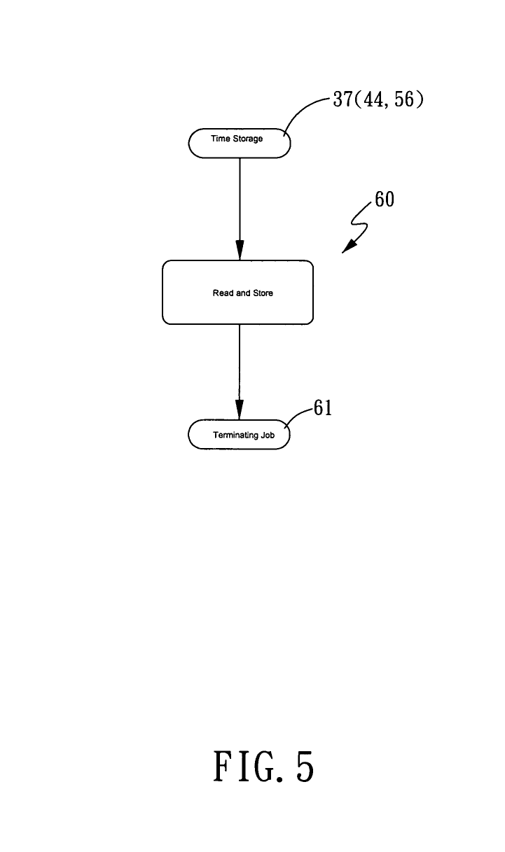

The steps for the storage of time 37, 44 and 56 are disclosed in FIG. 5, comprising:

The main step is to read and store 60: reading the sum of value of the period of time and the value of the interior counting, and storing the sum into the value of time and then terminating the job 61.

The present invention provides an easy way to encode. The processes are done by pressing multiple buttons simultaneously and it can also be done by pressing several individual buttons in different time to proceed the encoding processes. The MCU is able to calculate different status of coding by different programs.

While we have shown and described the embodiment in accordance with the present invention, it should be clear to those skilled in the art that further embodiments may be made without departing from the scope of the present invention.

1. An emitting device comprising:
a body having a plurality sets of buttons (12) and a rest button (13), the buttons (12) and the reset button (13) connected with an MCU (14) which is connected to a power supply system (15), a generator (16), a receiver (17) and warning lamps (18) and (19);
steps for encoding and emitting of the emitting device (10) comprises:
reset (21): the reset button (13) being pressed;
initial setting (210): a system establishing an initial value and the exterior power being shut down when the values becomes their original values;
reading the operation of the buttons (22): if no button is pressed (220) then go to the previous step;
reading the value of the first button (221): pressing the first button (120) and reading the stored value in the first button (120);
reading the value of the second button (222): pressing the second button (121) and reading the stored value in the second button (121);
reading the value of the third button (223): pressing the third button (122) and reading the stored value in the third button (122);
reading the value of the fourth button (224): pressing the fourth button (123) and reading the stored value in the fourth button (123);
the system proceeding the following steps after the four buttons are pressed:
sending (23): cooperating with the exterior power supply and sending a mixture of the read value of the buttons in a form of 32 bit code and 4 bit status value;
sending the codes per-set times (24): counting the times of sending, if the times reach the desired value, if no sending is completed then go to the previous step, if the sending is completed then go to the next step;
detecting change of the values of the buttons (25): detecting the values of the buttons, if no change is detected then go to read the previous step, if a change is detected then go to the next step;
checking the button is pressed or not (26): checking the button is pressed or not, if no, terminate the jab (27), if yes, go to time storage (28) to store time;
when encoding, using different button to set different functions, comprising:
encoding process (30): pressing at least one set of the first buttons simultaneously to re-set different codes for the buttons;
learning mold (40): pressing at least one set of buttons simultaneously to learn and confirm the codes;
quick encoding process (50): pressing the first button (120) and the second button (121) simultaneously to proceed quick encode.

2. An emitting device comprising:
a body having a plurality sets of buttons (12) and a rest button (13), the buttons (12) and the reset button (13) connected with an MCU (14) which is connected to a power supply system (15), a generator (16), a receiver (17) and warning lamps (18) and (19);
steps for encoding and emitting of the emitting device (10) comprises:
reset (21): the reset button (13) being pressed;
initial setting (210): a system establishing an initial value and the exterior power being shut down when the values becomes their original values;
reading the operation of the buttons (22): if no button is pressed (220) then go to the previous step;
reading the value of the first button (221): pressing the first button (120) and reading the stored value in the first button (120);
reading the value of the second button (222): pressing the second button (121) and reading the stored value in the second button (121);
reading the value of the third button (223): pressing the third button (122) and reading the stored value in the third button (122);
reading the value of the fourth button (224): pressing the fourth button (123) and reading the stored value in the fourth button (123);
the system proceeding the following steps after the four buttons are pressed:
sending (23): cooperating with the exterior power supply and sending a mixture of the read value of the buttons in a form of 32 bit code and 4 bit status value;
sending the codes per-set times (24): counting the times of sending, if the times reach the desired value, if no sending is completed then go to the previous step, if the sending is completed then go to the next step;
detecting change of the values of the buttons (25): detecting the values of the buttons, if no change is detected then go to read the previous step, if a change is detected then go to the next step;
checking the button is pressed or not (26): checking the button is pressed or not, if no, terminate the jab (27), if yes, go to time storage (28) to store time;
when encoding, using different button to set different functions, comprising:
encoding process (30): pressing the first button (120), the second button (121) and the third button (122) simultaneously to re-set different codes for the buttons;
learning mold (40): pressing the first button (120) and the third button (122) simultaneously to learn and confirm the codes;
quick encoding process (50): pressing the first button (120) and the second button (121) simultaneously to proceed quick encode.

3. The device as claimed in claim 1, wherein the processes for encoding (30) comprises:
activation of exterior power supply (30): activating the exterior power supply to proceed the encoding processes;
checking the change of the buttons (32): if no change is detected, checking whether it reaches the pre-set period of time (33), if it reaches the pre-set period of time such as 30 seconds, warning lamps (18) and (19) illuminate all the time, go to the previous step, if it does not reach the pre-set period of time, the warning lamp (35) flashes and the two warning lamps (18) and (19) flash and go to the previous step; if the value of the button is changed, checking whether it reaches the pre-set period of time such as (30) seconds, if no, then proceed time storage (37), if yes, then proceed encoding (38); the encoding (38) being generated by mixing the values of buttons, the value of time and value of RTCC to generate a 4 bit random code which is stored in a button corresponding thereto, the status of the value being stored in each value of button.

4. The device as claimed in claim 1, wherein the quick encoding process (50) comprises:
checking any change of the values of the buttons (500), if the first and the second buttons (51) are pressed simultaneously, the fist and the second buttons (120), (121) are in ON status, then go to the previous step; if the first, the second and the third buttons (52) are pressed simultaneously, and the three buttons (120), (121), (122) are ON, the time counter (53) is added by 1 (one) and goes to the previous step; if the situations are different from the situations mentioned above, checking whether the time reaches the pre-set period of time (54), if yes, then checking whether reaches the pre-set value of the counter (55), the pre-set value is five, if the accumulation of the value reaches to five, then go to the process of encoding (38) to proceed quick encoding and storing; if neither of the time and the value of the counter is reached, proceed the process of time storage (56); if the change of the value of buttons (51) is confirmed to be negative, then go to check whether the time reaches the pre-set time (57), if yes, the warning lamp off, if no, the warning lamp flashing (59), and go to the previous step.

5. The device as claimed in claim 1, wherein the learning mold (40) comprising:
activation of exterior power supply (41): activating the exterior power supply to proceed encoding processes;
checking the change of the buttons (42): if no change is detected, checking whether it reaches the pre-set period of time (43), if no, go to the previous step, if yes, it reaches the pre-sect period of time of (30) seconds, checking whether the time counter is zero (430), if no, proceed time storage (44), if it is zero, checking whether it reaches pre-set period of time which is about 10 seconds, if no, checking whether the button is pressed (432), if no, go to the previous step, if yes and the three buttons (120), (121), (122) or the first and the third buttons (120), (122) are pressed simultaneously, go to the time storage (44), if the button is other than the three buttons (120), (121), (122), then proceed storage of the read encoding by storing the codes and status read by legs into corresponding buttons, if the buttons are pressed other than the three buttons being pressed simultaneously, then check the time is within two seconds, if no, then go to the previous step by adding 1 (one) (450) to the time counter, if yes, checking the value of the time counter reaches the pre-set value (46), if no, then go to the time storage (44), if yes, then check whether it reaches the pre-set period of time (47), if yes, then proceed the time storage (44), if no, check whether a button is pressed (48), if no, go to the previous step, if yes, and the three buttons (120), (121), (122) are pressed simultaneously or the first and the third button (120), (122) are pressed simultaneously, then go to the status of time storage (44), if any other button is pressed, then proceed the storage of read code (49) by storing the code and the status read by legs into the corresponding buttons.

6. The device as claimed in claim 1, wherein steps for the storage of time (37), (44) and (56) comprises a main step to read and store (60): reading the sum of value of the period of time and the value of the interior counting, and storing the sum into the value of time and then terminating the job (61).
